(19) United States
(12) Patent Application Publication
(10) Pub. No.: US 2015/0156458 A1
(43) Pub. Date: Jun. 4, 2015

(54) METHOD AND SYSTEM FOR RELATIVE ACTIVITY FACTOR CONTINUOUS PRESENCE VIDEO LAYOUT AND ASSOCIATED BANDWIDTH OPTIMIZATIONS

(71) Applicant: AVAYA INC., Basking Ridge, NJ (US)

(72) Inventors: Stephen Whynot, Allen, TX (US); Michael Vernick, Ocean, NJ (US); Greg Osterhout, Coppell, TX (US)

(73) Assignee: AVAYA INC., Basking Ridge, NJ (US)

(21) Appl. No.: 14/095,605

(22) Filed: Dec. 3, 2013

(51) Int. Cl. H04N 7/15

(52) U.S. Cl. CPC H04N 7/152

(57) ABSTRACT

Disclosed is a system and method for calculating a relative activity factor from a plurality of endpoints in a video conference to affect display layout during the video conference.

### FIELD OF THE INVENTION

The field of the invention relates generally to viewing and display of video conference attendees.

### BACKGROUND OF THE INVENTION

In today's market, the use of video services, such as video conferencing, is experiencing a dramatic increase. Since video services require a significantly larger amount of bandwidth compared to audio services, this has caused increased pressure on existing communication systems to provide the necessary bandwidth for video communications. Because of the higher bandwidth requirements of video, users are constantly looking for products and services that can provide the required video services while still providing lower costs. One way to do this is to provide solutions that reduce and/or optimize the bandwidth used by video services.

### SUMMARY OF THE INVENTION

An embodiment of the invention may therefore comprise a method of providing a layout for a video conference comprising a bridge device and a plurality of endpoints connected to the bridge device, the method comprising via each of the plurality of endpoints, providing a video output to the bridge device, at the bridge device, calculating a relative activity factor for each of said plurality of endpoints based on each of the provided video outputs to the bridge, and displaying, at each of the plurality of endpoints, one or more of the endpoint outputs according to the calculated relative activity factors.

An embodiment of the invention may further comprise a s system for providing a layout for a video conference, the system comprising a bridge device, and a plurality of endpoints, wherein the bridge device is enabled to receive video streams from the plurality of endpoints and calculate a relative activity factor for each of the plurality of endpoints and the endpoints are enabled to display a layout of the video conference based on the relative activity factor.

### BRIEF DESCRIPTION OF THE DRAWINGS

FIG. 1 shows a block diagram of a system for a relative activity factor continuous presence video layout.

FIG. 2 shows a centralized conferencing system.

### DETAILED DESCRIPTION OF THE EMBODIMENTS

Some embodiments may be illustrated below in conjunction with an exemplary video communication system. Although well suited for use with, e.g., a system using switch(es), server(s), and/or database(s), communications en-points, etc., the embodiments are not limited to use with any particular type of video communication system or configuration of system elements.

Many video conferencing formats, mechanism and solutions are moving toward multi-stream continuous presence video conferencing. Many video conferencing solutions in the market use multi-conferencing units (MCU) in the network to process video. These solutions composite multiple streams in the network into one. This type of conferencing requires specialized hardware and may be expensive to deploy. Delay (due to delay in video transcoding, for example) can impact quality of service. Multi-stream can deliver multiple steams to an endpoint where the multiple streams can be composed locally. This allows for a lowering of delay and latency. This may tend to increase quality and scale and avoid proprietary hardware as well as require less infrastructure in a network. Bandwidth consumption may be affected, but this can be mitigated with cascading.

Choosing which steams to deliver to an endpoint and at what quality is provided for in this description, and invention. Also, sending more streams than needed can be distracting and wastes bandwidth. Sending streams with higher quality than needed may also waste bandwidth. In some situations, participants to a video conference may not want all video on a screen once the number of participants grows beyond a certain point, for example 5 to 6 participants, or more. The preference of participants may be factored automatically with the use of relative activity factor, or through explicit preferences. Accordingly, allocating space, by whichever method, on the display may allow efficient use of bandwidth for streams with more active participants. Utilization of layouts that utilize such relative activity factoring may provide cost and bandwidth savings. Further, the sum of individual resolutions of each video stream sent to an endpoint is optimally equal to, or comes close to, the resolution of the destination window on the display. This assists in ensuring that there is no wasted bandwidth, thus requiring downscaling to fit. Also, knowing the dimensions of a destination window in the network helps to optimize the delivered video streams. The destination window for a particular stream may also be dynamically changed in size during a conference and the size of the window can be communicated back to the media server or bridge device so that it can adjust the stream for its targets.

An embodiment of the current invention provides relative activity factor continuous presence video layout. The embodiment reduces resource requirements. The resource usage reduced may include network bandwidth, server-side memory due to reduced computational complexity and client-side memory due to reduced computational complexity.

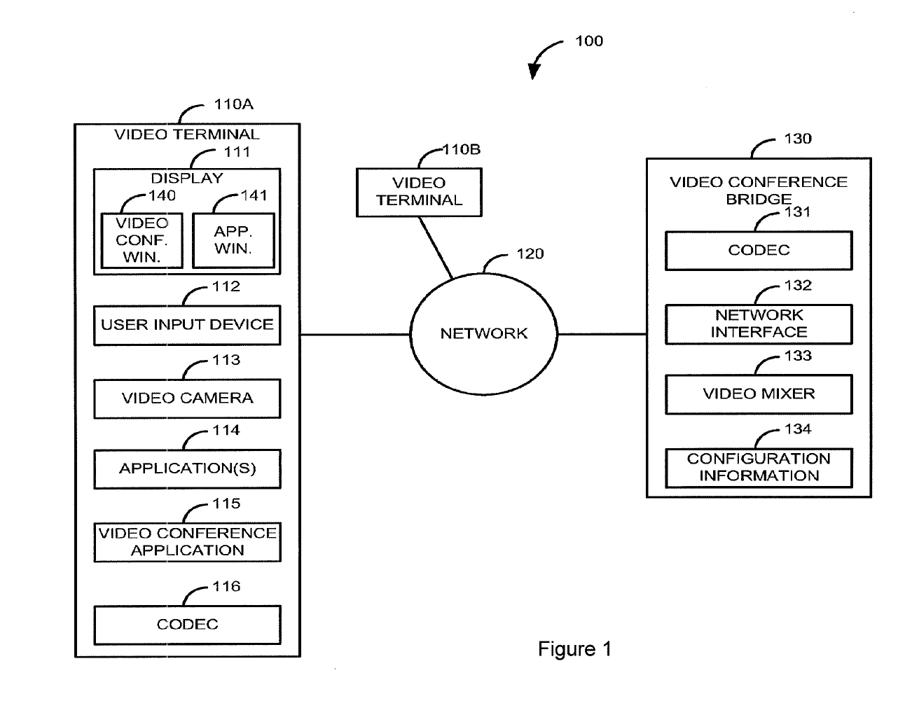

FIG. 1 shows a block diagram of a system for a relative activity factor continuous presence video layout. A system 100 comprises video terminals 110A-110B, network 120, and video conference bridge 130. Video terminal 110 can be any type of communication device that can display a video stream, such as a telephone, a cellular telephone, a Personal Computer (PC), a Personal Digital Assistant (PDA), a monitor, a television, a conference room video system, and the like. Video terminal 110 further comprises a display 111, a user input device 112, a video camera 113, application(s) 114, video conference application 115 and codec 116. In FIG. 1, video terminal 110 is shown as a single device; however, video terminal 110A can be distributed between multiple devices. For example, video terminal 110 can be distributed between a telephone and a personal computer.

Display 111 can be any type of display such as a Liquid Crystal Display (LCD), a Cathode Ray Tube (CRT), a monitor, a television, and the like. Display 111 is shown further comprising video conference window 140 and application window 141. Video conference window 140 comprises a display of the stream(s) of the active video conference. The stream(s) of the active video conference typically comprises an audio portion and a video portion. Application window 141 is one or more windows of an application 114 (e.g., a window of an email program). Video conference window 140 and application window 141 can be displayed separately or at the same time. User input device 112 can be any type of device that allows a user to provide input to video terminal 110, such as a keyboard, a mouse, a touch screen, a track ball, a touch pad, a switch, a button, and the like. Video camera 113 can be any type of video camera, such as an embedded camera in a PC, a separate video camera, an array of cameras, and the like. Application(s) 114 can be any type of application, such as an email program, an Instant Messaging (IM) program, a word processor, a spread sheet, a telephone application, and the like. Video conference application 115 is an application that processes various types of video communications, such as a codec 116, a video conferencing software/software, and the like. Codec 116 can be any hardware/software that can decode/encode a video stream. Elements 111-116 are shown as part of video terminal 11OA. Likewise, video terminal 11OB can have the same elements or a subset of elements 111-116.

Network 120 can be any type of network that can handle video traffic, such as the Internet, a Wide Area Net-work (WAN), a Local Area Network (LAN), the Public Switched Telephone Network (PSTN), a cellular network, an Integrated Digital Services Network (ISDN), and the like. Network 120 can be a combination of any of the aforementioned networks. In this exemplary embodiment, network 120 is shown connecting video terminals 11OA-11OB to video conference bridge 130. However, video terminal 11OA and/or 11OB can be directly connected to video conference bridge 130. Likewise, additional video terminals (not shown) can also be connected to network 120 to make up larger video conferences.

Video conference bridge 130 can be any device/software that can provide video services, such as a video server, a Private Branch Exchange (PBX), a switch, a network server, and the like. Video conference bridge 130 can bridge/mix video streams of an active video conference. Video conference bridge 130 is shown external to network 120; how-ever, video conference bridge 120 can be part of network 120. Video conference bridge 130 further comprises codec 131, network interface 132, video mixer 133, and configuration information 134. Video conference bridge 130 is shown comprising codec 131, network interface 132, video mixer 133, and configuration information 134 in a single device; how-ever, each element in video conference bridge 130 can be distributed.

A multipoint control unit (MCU) is a device commonly used to bridge videoconferencing connections as shown in FIG. 1. The multipoint control unit is an endpoint on the LAN that provides the capability for three or more terminals and gateways to participate in a multipoint conference. The MCU may consist of a mandatory multipoint controller (MC) and optional multipoint processors (MPs). An MCU or other media server may provide the interconnection between endpoints for a video conference. Simultaneous videoconferencing among three or more remote points is possible by means of the MCU. As noted, this is a bridge that interconnects calls from several sources (in a similar way to the audio conference call). All parties call the MCU, or the MCU can also call the parties which are going to participate, in sequence. There are MCU bridges for IP and ISDN-based videoconferencing. There are MCUs which are pure software, and others which are a combination of hardware and software. An MCU is characterized according to the number of simultaneous calls it can handle, its ability to conduct transposing of data rates and protocols, and features such as Continuous Presence, in which multiple parties can be seen on-screen at once. MCUs can be stand-alone hardware devices, or they can be embedded into dedicated videoconferencing units. The MCU consists of two logical components: A single multipoint controller (MC), and Multipoint Processors (MP), sometimes referred to as the mixer. The MC controls the conferencing while it is active on the signaling plane, which is simply where the system manages conferencing creation, endpoint signaling and in-conferencing controls. This component negotiates parameters with every endpoint in the network and controls conferencing resources. While the MC controls resources and signaling negotiations, the MP operates on the media plane and receives media from each endpoint. The MP generates output streams from each endpoint and redirects the information to other endpoints in the conference.

Some systems are capable of multipoint conferencing with no MCU, stand-alone, embedded or otherwise. These use a standards-based H.323 technique known as “decentralized multipoint”, where each station in a multipoint call exchanges video and audio directly with the other stations with no central “manager” or other bottleneck. The advantages of this technique are that the video and audio will generally be of higher quality because they don't have to be relayed through a central point. Also, users can make ad-hoc multipoint calls without any concern for the availability or control of an MCU. This added convenience and quality comes at the expense of some increased network bandwidth, because every station must transmit to every other station directly.

Continuing with FIG. 1, Codec 131 can be any hardware/software that can encode a video signal. For example codec 131 can encode one or more compression standards, such as H.264, H.263, VC-1, and the like. Codec 131 can encode video protocols at one or more levels of resolution. Network interface 132 can be any hardware/software that can provide access to network 120 such as a network interface card, a wireless network card (e.g., 802.11g), a cellular interface, a fiber optic network interface, a modem, a T1 interface, an ISDN interface, and the like. Video mixer 133 can be any hardware/software that can mix two or more video streams into a composite video stream, such as a video server. Configuration information 134 can be any information that can be used to determine how a stream of the video conference can be sent. For example, configuration information 134 can comprise information that defines under what conditions a specific video resolution will be sent in a stream of the video conference, when a video portion of the stream of the video conference will or will not be sent, when an audio portion of the stream of the video conference will or will not be sent, and the like. Configuration information 134 is shown in video conference bridge 130. However, configuration information 134 can reside in video terminal 11OA.

After a video conference is set up (typically between two or more video terminals 11O), video mixer 133 mixes the video streams of the video conference using known mixing techniques. For example, video camera 113 in video terminal 11OA records an image of a user (not shown) and sends a video stream to video conference bridge 130, which is then mixed (usually if there are more than two participants in the video conference) by video mixer 133. In addition, the video conference can also include non-video devices, such as a telephone (where a user only listens to the audio portion of the video conference). Network interface 132 sends the stream of the active video conference to the video terminals 11O in the video conference. For example, video terminal 11OA receives the stream of the active video conference. Codec 116 decodes the video stream and the video stream is displayed by video conference application 115 in display 111 (in video conference window 140).

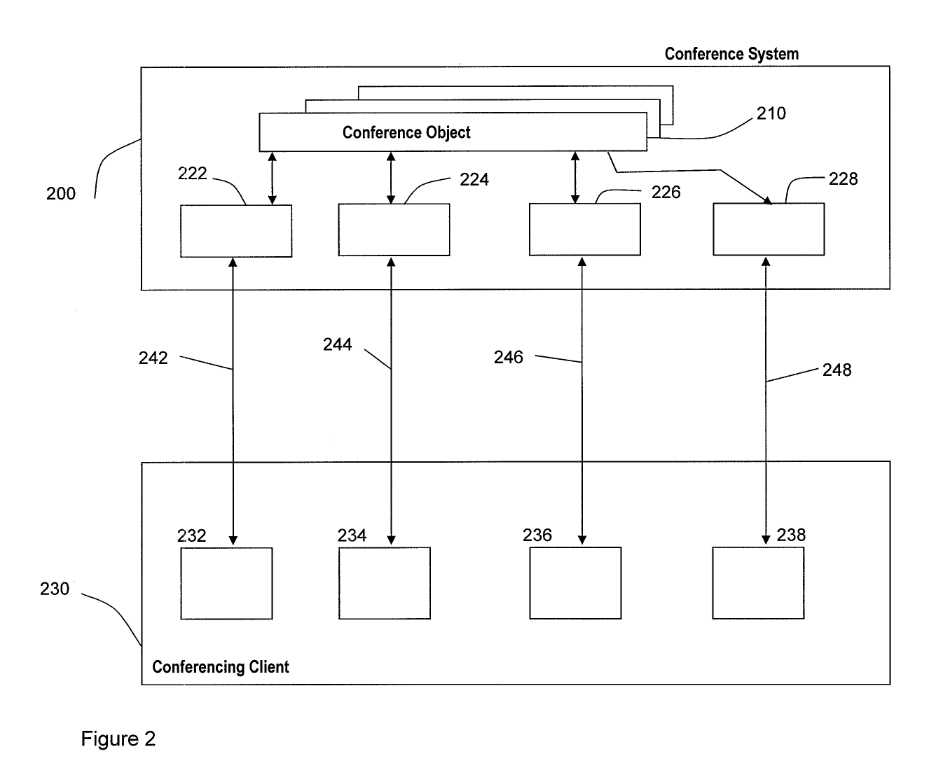

FIG. 2 shows a centralized conferencing system. The centralized conferencing system comprises a conference system 200 and a conferencing client 230. The conference system comprises a plurality of conference objects 210, a conference and media control client 222, a floor control server 224, foci 226 and a notification service 228. The conferencing client 230 comprises a conference and media control client 232, a floor control client 334, a call signaling client 336 and a notification client 238. The conference control server 222 communicates with the conference and media control client 232 via a conference control protocol 242. The floor control server 224 communicates with the floor control client 334 via a binary floor control protocol 244. The foci 226 communicate with the call signaling client 236 via a call signaling protocol 246. The notification service 228 communicates with the notification client 238 via a notification protocol 248.

As is understood, a video conferencing solution may utilize an MCU in a network to process video content. This may entail compositing multiple streams in the network into one stream. Specialized hardware may be required at an increased expense. Further video transcoding may result in high delays having quality of service impact. Multiple stream delivery to an endpoint lowers delay and latency and increases quality and scale. This is partially due to local composition. Additional hardware and infrastructure requirements in the network are lowered. It is noted that any increase that multiple streams may have on bandwidth consumption may be mitigated with cascading.

As is also understood, each attendee to a conference will be active for portions of the entire conference. Activity may rise and fall naturally during the conference as a participant speaks and then quietly listens and then speaks, and so on. Further, some types of activity may weigh differently in a RAF calculation. Speaking may weigh more substantially in the RAF calculation than textual input. The relative factors of the calculation may be determined by a developer or administrator. A relative activity factor (RAF) can be calculated for each attendee. The RAF may be dynamically calculated and may consider one or some of the following factors: motion detection, speaking time or textual inputs to the conference. Contributions that may impact a RAF calculation may also include non-speaking, or textual input, and non-motion factors. These factors may include screen sharing, web collaboration, remote control and other factors which indicate involvement in the conference. It is understood that a developer and/or administrator may choose from a large variety of factors to affect RAF and those chosen factors may vary from administrator/developer to administrator/developer. An administrator may be enabled to configure the behavior of RAF calculations and according adjustments using a bandwidth/quality sliding adjustment rather than selecting individual factors. The slider would range from aggressive bandwidth conservation to maximum quality, and would accompany a bandwidth top and bottom range at each notch to help the administrator make the decision. Additional administrator configuration could include a maximum number of windows allowable to be displayed. Another manner to control bandwidth is to provide a collection of layouts that have bandwidth ranges and labeled window characteristics, such as sizes, resolution, frame rates, etc.). The administrator interface may be a higher level control to provide flexibility to bandwidth control and user experience. It is also understood that there may be more factors indicative of presence that may be measurable and which may occur to users of a system that can be used. It is understood that various terms may be used throughout this specification to RAF matters. For example, an RAF rating, or determination, or calculation, or specification, or rating may be used to address the matter of the RAF for a particular user. These terms are not intended to be limiting to anything other than the matter of identifying an RAF for a particular user.

An RAF determination, or calculation, can be used to make informed decisions regarding user interface layout decisions. These decisions can range from which user to when to where to display images or indications of users participating in a conference. For instance, a participant with a lower RAF rating, or determination, may be placed in a smaller window with a possibly lower video quality. Accordingly, a lower network bandwidth will be used by a lower RAF user. Conversely, a participant with a higher RAF rating, or determination, may be placed in a larger window with a possibly higher video quality. A lower, or higher, RAF calculation may also influence the frame rate (temporal) as well as the resolution (spatial) aspects. A decrease in frame rate and a decrease in resolution will both lower bandwidth usage. Participants that are listening to a conference may not require their video output to be received by other participants at a high resolution or frame rate. Although, other factors may cause adjustment for these not actively speaking participants' RAF values and they may accordingly be transmitted at higher resolution and/or frame rate. However, a very high RAF could 30 fps (frame rate) and a lower RAF could use 15 fps, 7.5 fps, or even 3.75 fps, for example. Moreover, the frame rate and resolution may be dynamically adjusted to account for changes in RAF during the conference. Accordingly, the quality of a stream can be adjusted both temporally and spatially according to the RAF calculation. These adjustments may affect the temporal aspect more than the spatial aspect, or vice-versa. The temporal aspect and spatial aspect may also be affected equally. Conference settings, as determined by an administrator or developer may differently determine adjustments to temporal and spatial aspects. An entity may do testing about how best to utilize bandwidth using embodiments of the invention and set a baseline for adjustments. Those adjustments may be made fixed, or they may be made unfixed, to be adjusted by an administrator to accommodate individual situations. Whether fixed or unfixed, the separate layers can be adjusted individually or together to match the RAF calculation. Further, this type of RAF adjustment restriction may be automatic depending on settings. The decision to use a particular RAF algorithm for RAF calculations could be selectable by a user, an administrator, or both. It may also be a feature where only an administrator can set the configuration settings to help conserve bandwidth in the network.

A presenter or group of presenters may have a limit on the RAF floor value. A floor value would represent the minimum settings allowed to keep that presenter or group f presenters in a higher quality window, regardless of the current RAF calculation. This type of RAF range may be determined by the role of the presenter, or group of presenters, or by the type of stream being used. The type of stream may be a presentation stream, a cascaded MCU stream from another system or other type of stream that an administrator determines requires such treatment.

The RAF associated with particular user can also be used to effect the length of time that a user stays is a particular window when they are not currently speaking. This length of time since a previous active speaking period is termed RAF decay. For instance, as the time lengthens that a particular user has actively been a speaker, that user may move from higher to lower level windows. The rate that a user may move from higher to lower level windows is also affected by the previous RAF of that user. For instance, a user with a high RAF will “decay” from a high RAF window at a different rate than a user with a low RAF. A user that previously has not spoken, and therefore has a low RAF, will decay faster than a user that speaks frequently, and therefore has a high RAF. It is understood that any particular algorithm for utilizing various factors, such as RAF, time since last activity, length of last activity, can be written depending on user preferences. For instance, a particular user may prefer to provide more visibility to a user that recently had a long term of activity that to a speaker that has many, but short, terms of activity. All of these factors can be used to determine RAF and the rate of decay.

RAF decay allows users to focus on participants actively participating the most, and more recently. This RAF decay also allows for reduced bandwidth requirements for those that may be just listening to a conference and not actively participating. Accordingly, bandwidth usage is made efficient while maintaining a useful user experience.

In an embodiment of the invention, the media server performing a conference calculates the relative activity factor continuously for each person, or endpoint, in the conference. It is understood, that the media server may also be an MCU (Media Control Unit) which interacts more directly with each endpoint. As discussed, RAF is a dynamic value that reflects how often a participant, or endpoint, speaks or contributes to the conference. External inputs, such as motion detection, may increase or decrease the activity factor determination. The RAF is used to make decisions, at the media server or MCU, regarding the layout of the windows, or other type displays. These decisions include, but are not limited to, which participant to display and where and the quality at which to display each participant. For instance, a participant, or endpoint, with a lower RAF may be in a smaller window and possibly with a lower video quality. This lower rated RAF participant accordingly uses less bandwidth than otherwise. Likewise, a participant with a higher RAF may be in a larger window and displayed with a higher video quality.

RAF may also be utilized to determine the length of time that participant stays in a particular window when not speaking, or otherwise active. This, as discussed elsewhere herein, is referred to as RAF decay. Utilization of RAF and decay allows for focus on participants that may be currently inactive, but have recently exhibited some level of activeness.

The number of windows displayed, or affected by the RAF calculation, may be limited to, for example, four CP (continuous presence) windows by an administrator. In such a case, the RAF calculation will help optimally fill the windows and not waste bandwidth. The RAF algorithm will assist in intelligently selecting streams for the windows if there are more participants than windows to display streams. Accordingly, if there are enough windows for every participant to be seen, then depending on the RAF algorithm selected, the resolution, quality and temporal settings of some percentage of windows can be maximized while others are lowered. Also, The RAF algorithm set up may be without limits as to quality, if enough participants are active they may all be quality maximized. Another embodiment is where windows are filled based on RAF values. Each window has a specific quality associated with it, such as a current speaker window being at a preset quality and a somewhat lower RAF participant window being at a lower preset quality. Also, if a participant is already displayed in a window and that participant becomes a current speaker, for instance, the RAF algorithm may adjust which window receives which treatment in order to not have participants jump from one window to another. These embodiments contemplate dynamic alteration of layouts where there is a mix of high and low quality windows, or all low or all high depending on the RAF values.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of providing a layout for a video conference comprising a bridge device and a plurality of endpoints connected to said bridge device, said method comprising:
via each of said plurality of endpoints, providing a video output to said bridge device;
at said bridge device, calculating a relative activity factor for each of said plurality of endpoints based on each of said provided video outputs to said bridge; and
displaying, at each of said plurality of endpoints, one or more of said endpoint outputs according to said calculated relative activity factors.

2. The method of claim 1, wherein said bridge point is a multipoint control unit.

3. The method of claim 1, wherein said relative activity factor is comprised of said frequency of contributions from an endpoint.

4. The method of claim 3, wherein said contributions comprise verbal communications.

5. The method of claim 3, wherein said contributions comprise non-verbal communications.

6. The method of claim 1, wherein in said process of calculating said relative activity factor comprises dynamically calculating said relative activity factor.

7. The method of claim 7, wherein said dynamically calculated relative activity factor is used to determine how long a particular endpoint is displayed in a layout when said particular endpoint is not active.

8. The method of claim 1, said method further comprising limiting said layout to a predetermined number of windows.

9. The method of claim 8, said method further comprising adjusting at least one of said spatial settings and said temporal settings for each of said predetermined number of windows.

10. The method of claim 9, wherein said process of adjusting comprises dynamically adjusting at least one of said spatial settings and said temporal settings for each of said predetermined number of windows.

11. A system for providing a layout for a video conference, said system comprising:
a bridge device; and
a plurality of endpoints,
wherein said bridge device is enabled to receive video streams from said plurality of endpoints and calculate a relative activity factor for each of said plurality of endpoints and said endpoints are enabled to display a layout of said video conference based on said relative activity factor.

12. The system of claim 11, wherein said bridge device is a multipoint control unit.

13. The system of claim 11, wherein said relative activity factor is comprised of said frequency of contributions from an endpoint.

14. The system of claim 13, wherein said contributions comprise verbal communications.

15. The system of claim 13, wherein said contributions comprise non-verbal communications.

16. The system of claim 11, wherein calculation of said relative activity factor comprises a dynamically calculated relative activity factor.

17. The system of claim 16, wherein said dynamically calculated relative activity factor is used to determine how long a particular endpoint is displayed in a layout when said particular endpoint is not active.

18. The system of claim 11, wherein said bridge is further enabled to limit said layout to a predetermined number of windows.

19. The system of claim 18, wherein said bridge is further enabled to adjust at least one of said spatial settings and said temporal settings for each of said predetermined number of windows according to said relative activity factor calculations.

20. The system of claim 19, wherein said adjustment to at least one of said spatial settings and said temporal settings are performed dynamically.
